(19) United States
(12) Patent Application Publication
(10) Pub. No.: US 2010/0077725 A1
(43) Pub. Date: Apr. 1, 2010

(54) Piston-jet engine

(76) Inventor: Xin Wang, East Scarborough (CA)

Correspondence Address: XIN WANG, 3895 Lawerence Ave . East APT 1007, Scarborough, ON, M1G 3T3, CA

(21) Appl. No.: 12/238,590

(22) Filed: Sep. 26, 2008

(51) Int. Cl. F02K 5/02; F02B 33/40

(52) U.S. Cl. 60/247; 123/559.1

(57) ABSTRACT

The mainstream jet engine now is the turbo-jet engine. Here in this invention the turbine is replaced by a piston motor. This will increase fuel efficiency and separating the turning parts from the burning parts will benefit maintenance effort. Unlike traditional turbo-jet engine to use turbines to drive fans and compressors, this invention uses a rotary motor driven by high pressure fluid generated by separate working chambers piston engine to drive fans and compressors

Sealing is a major issue in engine design. Without proper sealing between moving parts, the working media will loose pressure and the power output will be low. So tradition rotary engine has sealing problems due to its complex movement of pistons. Here a linear movement piston is used when the working media is gas and a rotary piston when the working media is fluid, thus solving the problems with sealing, cooling and lubricating difficulties.

This invention uses some techniques developed in the previous inventions by me, application No. 60957442 and 11846550.

The piston motor (4) is embodied by a rotary piston hydraulic motor, see FIG. 2 and FIG. 3. The rotary piston (13) slices through a shaft (10) slot and turns with the shaft (10) at the same time. A circle is formed if the rotation point is at the middle point of the piston (13) as the reference circle (8). But the piston (13) rotates at the center point of the shaft (10) which is not the middle point of the piston (13). So the piston does two movements at the same time: first slices back and forth in the shaft (10) slot, secondly turns around the center point of the shaft (10). This combined movement of the piston (13) can produce all kinds of closed-curve piston (13) tip contours. Here a symmetric contour (9) is chosen as the piston cylinder inside contour (9) in which the length deviation of the piston (13) relative to the reference circle (8) at each end of the piston is equal. So this contour (9) is the closest to the regular reference circle (8). But the contour do not necessarily has to be symmetric, adjusting the angle between the piston (13) and the contour (9) to generate smoother piston movement is possible depending on the torque output type.

The eccentric turning point of the piston (13) generate torque output when high pressure fluid is pumped into the rotary motor (4) through inlet (22) and the piston (13) is forced by the cylinder contour (9) to slide through the shaft (20) slot to seal the gap between the cylinder (9) and the piston (13). Traditional 4 stroke engines have only one chamber to do all the works, that is why they are called 4 stroke engines. Here this invention has different work done in different places, thus it has separate chambers for different works instead of only one chamber for all the works. It has the air compression chamber (51), combusting gas expansion and exhaust chamber (41) and high pressure fluid generating chamber (54), which are connected by a piston connection rod (44), The gas mixing and combusting chamber (25) or (40), which is connected to the combusting gas expansion and exhaust chamber (41) by the pipe (53).

The special fluid (fluid) is used instead of a crank shaft as the media to transform linear momentum into torque. Since the fluid is a denser media than gases, it is better sealed in the rotary motor than gases. The expansion gas only works in the linear piston movement. Because the fluid (34) is in direct contact with all the working chambers, it makes the engine better cooled and lubricated. It also serves as a perfect buffer for fuel explosion.

The check valve (64) uses plate spring (61) as the recovery force instead of torque spring because the recovery force spreads more evenly.

### DESCRIPTIONS OF VIEWS IN THE DRAWINGS

FIG. 1 The axis cut-away view of the piston-jet engine, piston motor (4) to drive fans and compressors in a jet engine. Traditional jet engines take energy out of the jet to drive the turbine. Here the compressors and fans are driven by a separate piston engine, which adds energy to the jet.

FIG. 2 The radial cut-through view of the piston motor (4) is embodied by a rotary piston hydraulic motor. The rotary piston (13) slices through a shaft (10) slot and turns with the shaft (10) at the same time.

Traditional piston engines use circular pistons and cylinders. Here the cylinder is non-circular and the piston is a rectangular plate.

FIG. 2a piston in various positions

FIG. 2b piston in horizontal position

FIG. 2c piston and shaft movement directions

FIG. 2d piston in vertical position

FIG. 3 is a engineering drawing of the embodiment of the is a engineering drawing of the embodiment of the design in FIG. 2. The radial and axis cutaway view of the piston motor (4) is embodied by a rotary piston hydraulic motor. The plate piston is pushed by liquid from the inlet to rotate.

FIG. 3a and FIG. 3b are the section views of A-A and B-B

FIG. 4 The power train sketch of using a linear piston-fluid-rotary piston combination to drive the fan and compressors in a jet engine.

FIG. 5 The radial and axis cutaway view of the linear piston engine of divided chambers uses three and more pistons to form a linear multi working chambers engine.

Tradition piston engines use one chamber to do all the works of compress, emit, combustion. Here different chambers are used to do different works.

FIG. 5a and FIG. 5b are the section views of A-A and B-B, which is the assembly of the linear movement piston engine.

FIG. 6 The radial and axis cutaway views of the linear piston engine. When the valve core (36) is turned in certain degree the power lines (37),(57),(53) and the exhaust pipe (52) connected to the valve (58) switch connection, therefore the pipe lines (37),(57) connecting the expansion chambers (41) with the valve (58) work alternatively as inlet and outlet of the expansion chambers.

FIG. 7 The radial cutaway view of a shaft and hole tolerance. To add metal powder (metals like pure copper or lead, not chemical salts of them), with its diameter less than the tolerance, better less than half of the tolerance of the structure into liquid to improve energy conductivity.

FIG. 8a and FIG. 8b are the axis cutaway views of the high pressure check valve (64) is made of a turning plug plate (65) in open and closed positions in each view above, around a pivot (63) with a cone rubber plug (62) and plate spring (61) at each side of the plug plate (65).

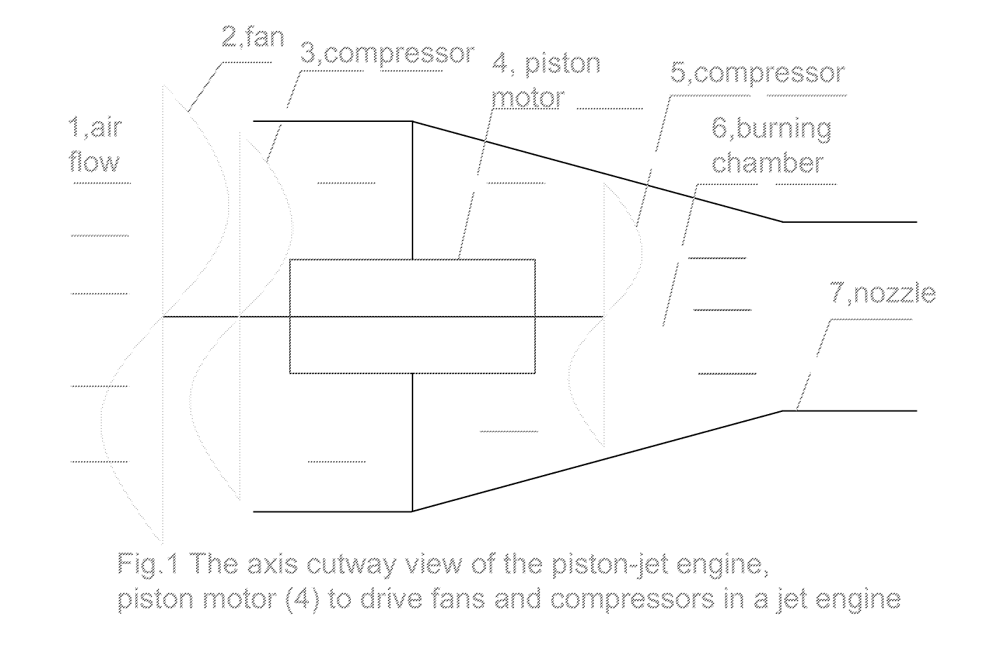

1. To use a piston motor (4) to drive fans and compressors in a jet engine. See FIG. 1. So it is called piston-jet engine.

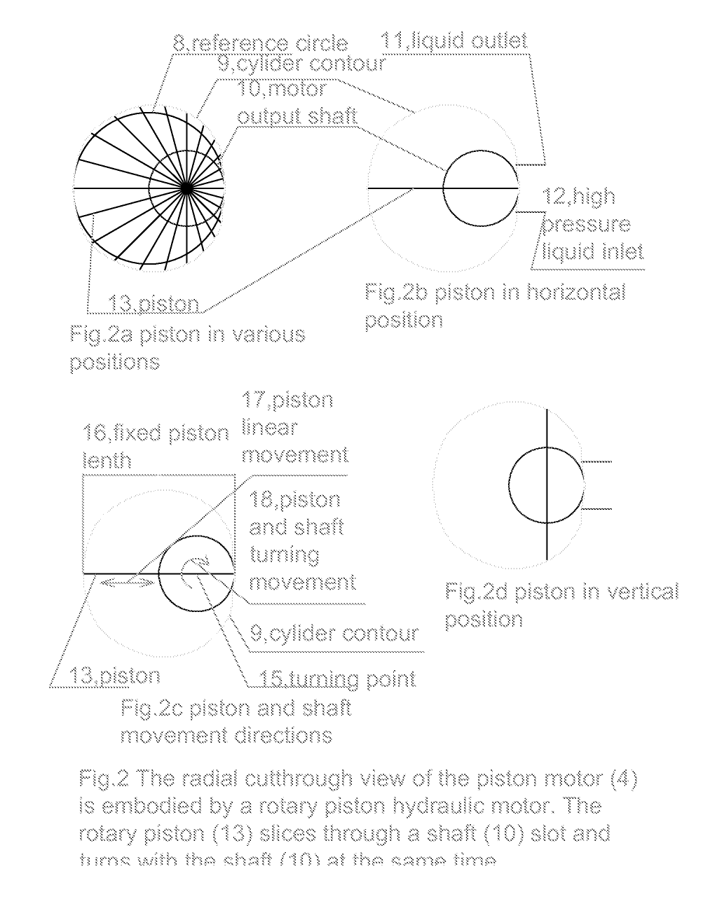

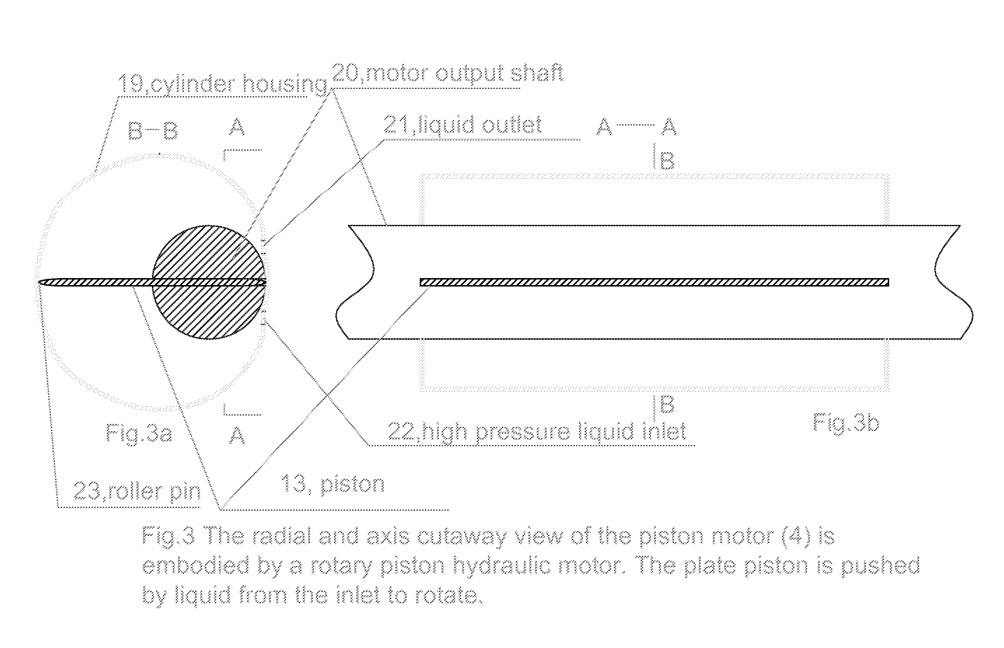

2. To use a plate piston (13) and slotted shaft (20) and a non-circular cylinder structure shaped as the said piston (13) glides through the said shaft (10) slot to make linear movement and rotates at the center point of the said shaft (10) at the same time, the combined linear and circular movements form the cylinder inside contour (9) along which the piston movement is guided, see FIGS. 2 and 3.

3. The said piston (13) with the cylinder contour (9) and shaft (10) forms a rotary hydraulic motor (4) structure, which can be used as compressors and hydraulic motors and engines, see FIG. 3 by working with different kinds of media.

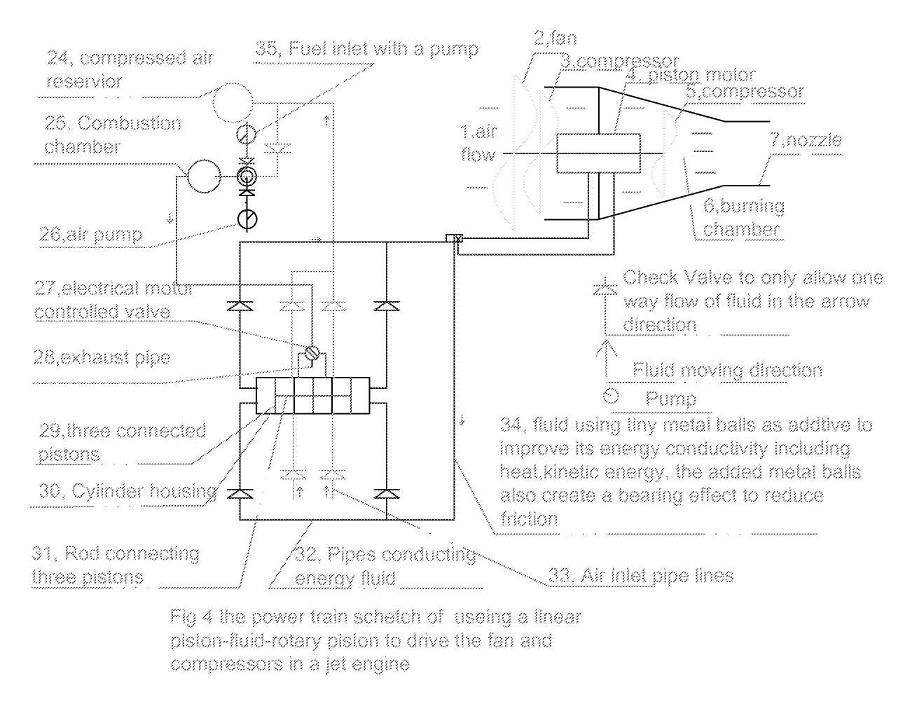

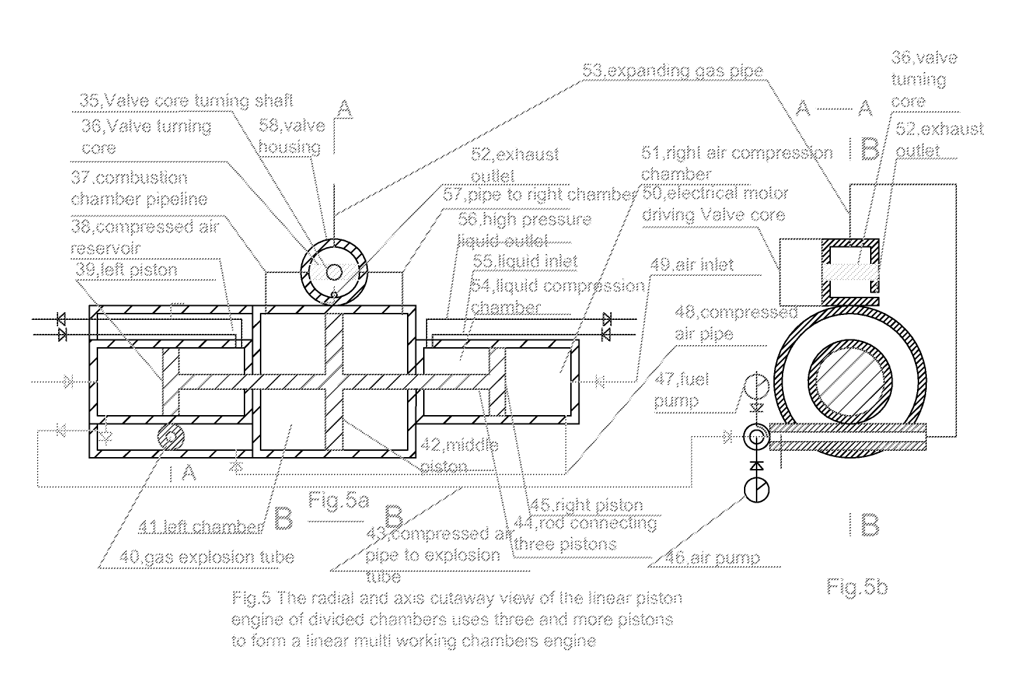

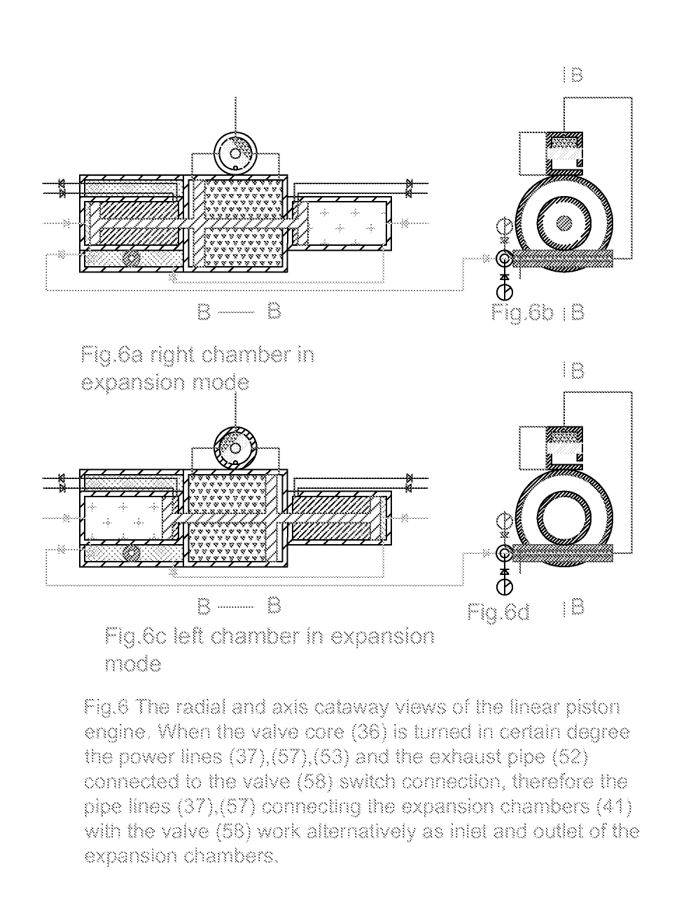

4. To use a piston-fluid-rotary piston in the engine power train in stead of piston-crank shaft structure, this improvement has the linear piston momentum transformed into rotary torque with the engine better cooled and lubricated, improving efficiency and life time, see FIGS. 4 and 5.

5. To use roller pin (23) at the tip of the piston (13) to reduce wear and to seal the piston (13) with the cylinder contour (9), see FIG. 3.

6. A engine of divided chambers uses three and more pistons to form a linear multi working chambers engine, see FIG. 4. The air compression chamber, combusting gas expansion and exhaust chamber and high pressure fluid generating chamber are connected by a piston connection rod (44). The gas mixing and combusting chamber (25) or (40) is connected to the combusting gas expansion and exhaust chamber (41) by the pipe (53).

7. To use the combusting chamber (25) heat waste to heat the compressed air before it enters the combusting tube (40) by putting the tube (40) inside the compressed air reservoir (38), thus cooling the engine and collecting the waste heat to do work, thus improving fuel efficiency.

8. To use a electrical motor controlled core turning valve (58) as the power flow control switch. When the valve core (36) is turned in certain degree the power lines (37),(57),(53) and the exhaust pipe (52) connected to the valve (58) switch connection, therefore the pipe lines (37),(57) connecting the expansion chambers (41) with the valve (58) work alternatively as inlet and outlet of the expansion chambers (41), a piston back and forth movement cycle is established.

9. To use a electrical motor (50) to drive a valve core (36) to control the pistons (42),(45),(39) movements. The piston movement cycle time is the same as the electrical motor (50) cycle time.

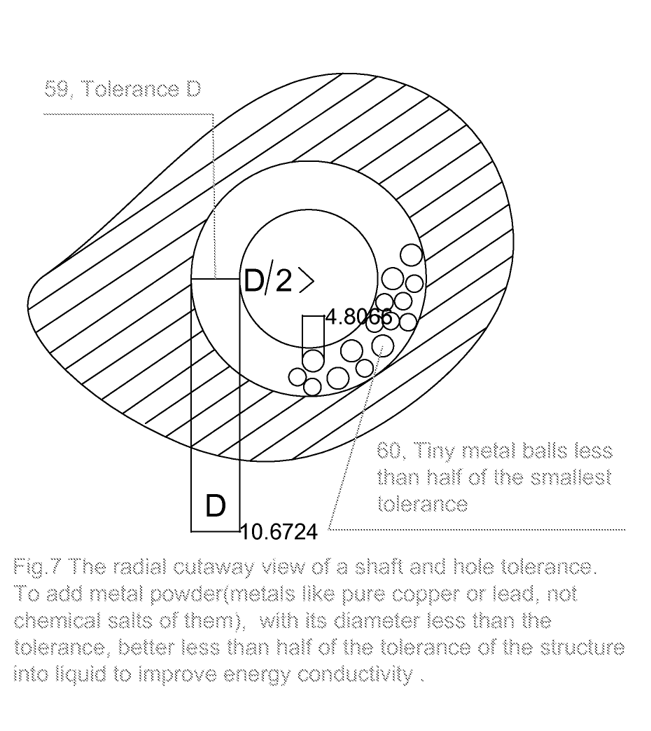

10. to add metal powder (metals like pure copper or lead, not chemical salts of them), with its diameter less than the tolerance, better less than half of the tolerance and hardness less than the structure materials, into liquid like lubricant oil or hydraulic oil to improve energy conductivity (kinetic and heat) and reduce ware between moving parts by creating bearing effect, this added metal balls can also repair ware damages if the damage is minor, see FIG. 4 and FIG. 7, for fluid (34). So the liquid serves as coolant, lubricant, power transmitter and maintenance substance.

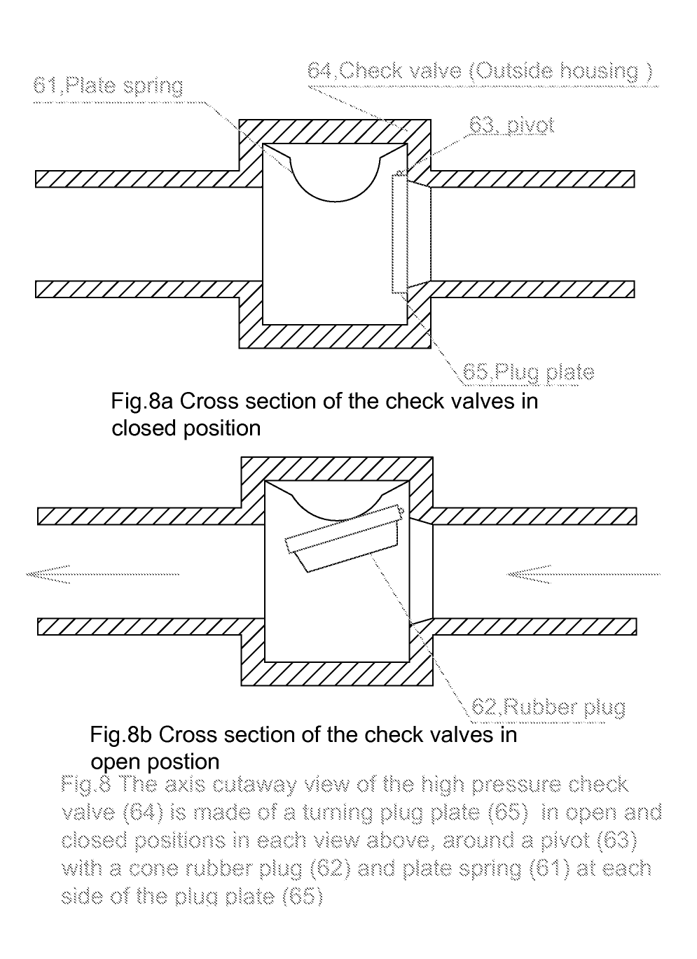

11. The high pressure check valve (64) is made of a turning plug plate (65) around a pivot (63) with a cone rubber plug (62) and plate spring (61) at each side of the plug plate (65), see FIG. 8. This plate spring-rubber cone plate structure ensures sealing under high pressure and quick response when the movement of fluid changes directions.
